(19) United States
(12) Patent Application Publication
(10) Pub. No.: US 2007/0231229 A1
(43) Pub. Date: Oct. 4, 2007

(54) Methods for Reducing Particulate Matter Emissions From Diesel Engine Exhaust Using Ethanol/Diesel Fuel Blends in Combination with Diesel Oxidation Catalysts

(76) Inventors: Alan Robert Semple Rae, Landenberg, PA (US); Robert Leslie Hall, Telford (GB)

Correspondence Address: ARNOLD & PORTER LLP;ATTN: IP DOCKETING DEPT., 555 TWELFTH STREET, N.W., WASHINGTON, DC, 20004-1206, US

(21) Appl. No.: 10/588,267

(22) PCT Filed: Feb. 9, 2005
(86) PCT No.: PCT/US05/03665

§ 371 Date: Jun. 6, 2007

Related U.S. Application Data
(60) Provisional application No. 60/542,470, filed on Feb. 9, 2004.

(51) Int. Cl. B01D 53/34; B01J 8/00; C10L 1/00

(52) U.S. Cl. 423/213.2

(57) ABSTRACT

Considerable progress has been made in recent years in reducing toxic exhaust emissions from diesel engines. Diesel oxidation catalysts for example are finding increasing use in reducing carbon monoxide, hydrocarbons and the soluble organic fraction of particulate matter in such emissions. Recent innovations in surfactant stabilizing additives now enable ethanol to be blended with diesel fuel in clear, stable solutions. On combustion, ethanol/diesel fuels generate less toxic emissions than the base diesel, but surprisingly when used in conjunction with diesel oxidation catalysts, particulate matter especially is dramatically reduced. The effectiveness of a diesel oxidation catalyst attached to a diesel engine exhaust is unexpectedly enhanced by the presence of ethanol in the diesel fuel.

### TECHNICAL FIELD

This invention relates to a pollution abatement process, and more particularly to a process for reducing the level of pollutants from the exhaust of a diesel engine.

### BACKGROUND OF THE INVENTION

Diesel exhaust is composed of a mixture of many different toxic chemicals. Diesel engines rely on heat, generated during the compression cycle, for ignition rather than an electrical spark as in gasoline engines. Because of this needed compression, diesel engines are heavier and bulkier than gasoline engines. They operate with less highly refined fuel and consume less fuel per horsepower per hour. The toxic chemicals of most concern in diesel exhaust are the oxides of nitrogen (NOₓ, e.g., nitric oxide, nitrogen dioxide), carbon monoxide, sulfur dioxide, aldehydes, primarily formaldehyde, acetaldehyde and acrolein, and various hydrocarbon particles, as well as unburnt hydrocarbons.

In this regard, diesel engine exhaust contains both hydrocarbons that are vapors or gases at ambient temperatures and hydrocarbons that have low vapor pressures at such temperatures and, as a result, condense onto the carbonaceous particulates created in the combustion process (the so-called “Soluble Organic Fraction” or “SOF”). Diesel exhaust also contains high levels of sulfur in the form of sulfur dioxide (SO₂). When SO₂ oxidizes, it is converted to SO₃, which then readily combines with water present in the exhaust to form sulfuric acid. Any sulfuric acid condensation will increase the measured particulate matter load of the exhaust gas and such condensation occurs more readily when hydrocarbons, especially the particulates, are present in the exhaust.

There are several different methods currently implemented for reducing diesel exhaust gas emissions, including the modification of engine design and operating parameters; the design of “cleaner” burning fuels; the use of catalytic converters and diesel oxidation catalysts (DOC) for the reduction of carbon monoxide, hydrocarbon, NOₓ, and particulate matter; the use of exhaust gas recycling (EGR); the use of selective catalytic reduction (SCR); and the use of particulate filters.

Nonetheless, in the effort to reduce diesel exhaust emissions, there is a dilemma when trying to reduce particle and NOₓ emissions simultaneously, because there is a correlation between the formation of NOₓ on one hand and of the remaining pollutants on the other. For instance, it is possible to reduce NOₓ emissions by internal measures, such as EGR, which in turn lower the temperature in the cylinder of the engine. However, lower operating temperatures result in increased emissions of particles, unburnt hydrocarbons and carbon monoxide. In addition, efficiency and effectiveness of the diesel engine is impaired, and therefore fuel consumption and carbon dioxide emissions increase. If, however, the combustion in the engine is optimized with regard to efficiency and performance, then formation of particulate matter and NOₓ will increase.

As such, there remains a need for improved methods for reducing and removing toxic emissions from the exhaust gas of diesel engines.

### SUMMARY OF THE INVENTION

Considerable progress has been made in recent years in reducing toxic exhaust emissions from diesel engines. Diesel oxidation catalysts for example are finding increasing use in reducing carbon monoxide, hydrocarbons and the soluble organic fraction of particulate matter in such emissions. Recent innovations in surfactant stabilizing additives now enable ethanol to be blended with diesel fuel in clear, stable solutions. On combustion, ethanol/diesel fuels generate less toxic emissions than the base diesel, but surprisingly when used in conjunction with diesel oxidation catalysts, particulate matter especially is dramatically reduced. The effectiveness of a diesel oxidation catalyst attached to a diesel engine exhaust is unexpectedly enhanced by the presence of ethanol in the diesel fuel.

As such, in one aspect of the invention, methods of reducing particulate matter content of diesel engine exhaust are provided. In general, the methods of the invention comprise operating a diesel engine utilizing as the fuel an ethanol/diesel fuel blend; and contacting the exhaust resulting from the combustion of the ethanol/diesel fuel blend with a diesel oxidation catalyst (DOC) for an amount of time sufficient to reduce the particulate matter content by at least 25%, preferably by at least 30%, and more preferably by at least 40%, as compared to the particulate matter content of diesel engine exhaust resulting from the combustion of diesel fuel alone.

### DETAILED DESCRIPTION

Whilst the addition of ethanol as an oxygenate to improve the combustion of shorter chain gasolines is gathering momentum as methyl tertiary butyl ether (MTBE) is being phased out due to environmental considerations, only recently has it become feasible to blend ethanol with diesel fuels. Ethanol, being polar, resists dissolution in long chain hydrocarbon fuels such as diesel. However, as described in further detail below, clear blends of ethanol and diesel are now made available by stabilizing the two at the molecular level with surfactants such as the blends of non-ionic species including alkoxylated fatty acids and/or alkanolamides, as described in PCT Publications WO 98/17745 and WO 02/088280, both of which are hereby incorporated by reference in their entireties. Such fuel blends benefit from the contribution of ethanol in reducing smoke, the soot content of particulate matter and other toxic emissions from diesel combustion, e.g., nitrogen oxides and carbon monoxide.

However, the combined effect of ethanol-containing diesel and DOC on the particulate matter content of the products of combustion or the impact of ethanol on enhancing the ability of the DOC to reduce particulate matter (PM), i.e., two separate “first test situations”—(a) ethanol+DOC together (tailpipe) and (b) impact of ethanol on improving the performance of the DOC (tailpipe compared with engine out), have not been reported to date.

Methods of the Invention

In accordance with the present invention, it was unexpectedly found that the use of ethanol/diesel fuel blends in combination with diesel oxidation catalysts (DOC) synergistically reduce particulate matter (PM) in diesel engine exhaust. More particularly, it was unexpectedly found that the effectiveness of a diesel oxidation catalyst (DOC) in reducing particulate matter was unexpectedly enhanced in the presence of ethanol. In a preferred embodiment, the methods of the invention reduce particulate matter while still reducing NOₓ emissions.

As such, in one aspect of the invention, methods of reducing particulate matter content of diesel engine exhaust are provided. In general, the methods of the invention comprise operating a diesel engine utilizing as the fuel an ethanol/diesel fuel blend; and contacting the exhaust resulting from the combustion of the ethanol/diesel fuel blend with a diesel oxidation catalyst (DOC) for an amount of time sufficient to reduce the particulate matter content by at least 25%, preferably by at least 30%, and more preferably by at least 40%, as compared to the particulate matter content of diesel engine exhaust resulting from the combustion of diesel fuel alone.

More particularly, when using base diesel fuels, a typical DOC will reduce PM in diesel engine exhaust by less than 25%. However, it has been found that in the presence of 7% by volume ethanol in the diesel fuel, a DOC can reduce PM to a greater extent than would be expected based on the use of a DOC alone and the use of an oxygenate fuel composition alone. In this regard, a synergy of action can unexpectedly be seen in the reduction of PM when a DOC is used in combination with ethanol/fuel mixtures. Moreover, the overall content of NOₓ, as well of other pollutants, is still reduced.

Appraisal of other oxygenates has been shown to exhibit less of an effect than observed with ethanol in the methods of the present invention, which ostensibly has a greater impact on DOC performance than evidenced in the prior art. SAE 1999-01-3595, Potentiality of Oxygenated Synthetic Fuel and Reformulated Fuel on Emissions from a Modern DI Diesel Engine. By way of reference, previous research on fuel oxygenates, for example on a 10% blend of Diglyme (diethylene glycol dimethyl ether—C6H1403) with diesel, achieved a soot reduction of 11% compared with the base diesel. SAE 1999-01-1137, Effects of DGM and Oxidation Catalyst on Diesel Exhaust Emissions. Diglyme has a slightly higher oxygen content (35.8%) than ethanol (34.8%). As used herein, “soot” refers to the dry portion of particulate matter (PM), and changes in soot levels correlate to changes in PM.

Ethanol/Fuel Mixture

The use of fuel grade ethanol blended with diesel imparts desirable combustion characteristics to the overall fuel blend; such as improved fuel stability, lower smoke and particulate matter, lower CO and NOₓ emissions, improved antiknock characteristics, and/or improved anti-freeze characteristics. However, use of ethanol in combination with a diesel fuel has previously posed problems, wherein the ethanol/diesel fuel mixture tends to separate into two distinct phases, especially when water is present, which renders the resultant mixture unsuitable for use as a combustible fuel. However, the recent development of improved fuel additives has permitted ethanol, including hydrous ethanol, to be blended satisfactorily with conventional diesel fuel without forming two phases.

Thus, in one aspect of the invention, a fuel blend comprising a diesel fuel, an ethanol oxygenator, and a fuel additive is provided. The fuel blends may optionally include other chemical additives such as cetane improvers, organic solvents, antifreeze agents, and the like. Further, the fuel blends may, or may not comprise water. Preferred fuel blends include those described in WO 98/17745 and WO 02/088280, both of which are herein incorporated by reference in their entireties.

The presence of the fuel additive ensures that the fuel blend will form a consistent stable homogenous composition and creates a monolayer simultaneously; a result of which leads to a better, more complete burn which reduces pollution and increases miles per gallon. Without being limited by theory, an ethanol/diesel fuel blend, is able to combust more precisely with a cooler charge to thereby reduce the iron-formates present from the aldehyde peracids and peroxide reactions normally attributable to engine degradation.

The fuel blends of the invention form a stable, clear and homogeneous composition, even in the presence of water. Therefore, according to a further feature of the invention, an ethanol/diesel fuel blend is provided, which optionally includes an amount of water, and wherein the fuel blend is a substantially stable, substantially clear and substantially homogeneous composition.

Determination of whether the fuel blend is substantially stable, substantially clear and substantially homogeneous is within the level of ordinary skill in the art. However, a measure of when a fuel blend is substantially stable, substantially clear and substantially homogeneous involves a determination of whether the fuel blend is at or near its cloud point. In this regard, conductivity of the fuel blend may serve as an indication of cloud point. For example, water has a conductivity of 100 mS cm⁻¹, and an alcohol, e.g., ethanol, has a conductivity of 20 to 30 mS cm⁻¹. Fuels, such as gasoline or diesel, being non-polar, have a conductivity of substantially zero. In contrast, a non-homogenous mixture of a fuel, such as gasoline or diesel, optionally including an alcohol, such as ethanol, will have a relatively high conductivity reading, and as homogeneity is approached, the conductivity will reduce and will reach a minimum when the composition is a clear homogenous solution.

The conductivity may be measured at varying temperatures, with substantially ambient temperatures being preferred and particularly at 25.1° C. Conductivity values given hereinafter generally relate to such values when measured at 25.1° C. Furthermore, since it is known that conductivity may vary with temperature, any conductivity values taken at differing temperatures should be calibrated as if measured at 25.1° C.

1. Diesel Fuel

The amount of diesel fuel blended to form the ethanol/diesel fuel blend of the invention may be from about 60% v/v to about 95% v/v, based on the total volume of the fuel consumption. The diesel useful in the ethanol/diesel fuel blends of the invention may comprise petroleum diesel, biodiesel, middle distillate fuels, or any combinations thereof, in any ratio of from 99:1 to 1:99 v/v.

The petroleum diesel fuel of the fuel blend of the invention may generally be obtained from the distillation of petroleum, and its efficiency can be measured by the cetane number. Suitable diesel fuels for use in accordance with the invention generally have a cetane number of from 35 to 60, preferably from 40 to 50.

The diesel fuels will preferably have a 90% point distillation temperature in the range of about 295° C. to about 390° C., and in one embodiment about 330° C. to about 350° C. The viscosity for these fuels typically ranges from about 1 to about 24 centistokes at 40° C. The diesel fuels may be classified as any of Grade Nos. 1-D, 2-D or 4-D, as specified in ASTM D975 (or equivalent Canadian or European standards, e.g., EN590-1999). In one embodiment, the diesel fuel is an ultra low sulfur diesel fuel (ULSD) having a maximum of 50 ppm sulfur and a 95% distillation temperature of less than about 345° C. In another embodiment, the diesel fuel has a sulfur content of up to about 0.05% by weight as determined by the test method specified in ASTM D2622-87 (or equivalent Canadian or European standards, e.g., EN590-1999). In yet another embodiment, the diesel fuel is a chlorine-free or low-chlorine diesel fuel characterized by a chlorine content of no more than about 10 ppm.

Preferably, when the fuel of the invention is a blend of biodiesel and a petroleum diesel, it may comprise up to 50% v/v biodiesel, for example from 1 to 50% v/v, preferably from 5 to 30% v/v, more preferably from 10 to 20% v/v.

2. Ethanol

The amount of ethanol oxygenator may vary depending, inter alia, upon the nature of the fuel, but may be in an amount of from about 1 to about 25% v/v, preferably about 1 to about 10% v/v, and more preferably about 7% v/v.

The ethanol may be produced from fossil fuel feedstocks or by fermentation of sugars derived from grains or other biomass materials. Therefore, ethanol suitable for use in accordance with the fuel blends of the invention may be fuel grade ethanol derived from yeast or bacterial fermentation of starch-based sugars. Such starch-based sugars may be extracted from corn, sugarcane, tapioca and sugar beet.

Alternatively, fuel grade ethanol may be produced via known dilute and/or concentrated acid and/or enzymatic hydrolysis of a particular biomass material, for example, from waste industrial sources including, cellulosic portions of municipal solid waste, waste paper, paper sludge, saw dust. Biomass may also be collected from agricultural residues including, for example, rice husks and paper-mill sludge.

A suitable fuel grade ethanol for use in accordance with the invention may contain none or only contaminant levels of water. Alternatively, a suitable fuel grade ethanol for use in accordance with the invention may contain higher amounts of water, for example, up to about 5% w/w (hydrous ethanol).

3. Fuel Additive

The concentration of the additive in the fuel composition may vary depending, inter alia, upon the nature of the fuel, however, the concentration can be very low, typically of the order of from 0.5:1000 to 50:1000 v/v, preferably from 1:1000 to 50:1000 v/v, preferably 1:100 to 5:100 v/v.

The fuel additive of the invention may be any fuel additive which results in a substantially stable, substantially clear and substantially homogenous ethanol/diesel fuel blend. The preferred fuel additive of the invention is a non-ionic surfactant and preferably a blend of surfactants. It is a preferred feature of this invention that the surfactants be selected by their nature and concentration that, in use, the additive (as well as any water or other non-fuel liquid present) be solubilized within the fuel. For this purpose it is convenient to have regard to the hydrophilic-lipophilic balance (HLB) of the surfactant, the value being calculated according to the expression.

$$H L B = \frac{mol . wt of hydrophilic chain \times 20}{total mol . wt .}$$

The values will depend on the length of the hydrophilic chain, typically an ethoxylate chain. The length of the chain will increase the extent of solubilization because of a greater ability to solubilize. The invention has the ability to unify the HLB requirements of any liquid fuel, which in turn allows for one dose to be used in any fuel from C5 carbon chains up.

Thus, according to a preferred aspect of the invention a fuel additive is provided comprising an oleic alkanolamide and an alkoxylated oleic. The ratio of the oleic acid alkoxylate to the oleic alkanolamide may vary, but preferably may be from about 99:1 to about 1:99 v/v, more preferably from about 3:1 to about 1:1 v/v, and still more preferably about 1:1 v/v.

The oleic alkanolamide of the fuel additive may preferably be an ethanolamide, and more preferably a diethanolamide. Especially preferred are the diethanolamides and particularly the super diethanolamides.

The oleic acid ethoxylate may be derived form a variety of feedstocks, readily available worldwide. However, in a preferred embodiment of the invention the oleic acid ethoxylate may be produced by ethoxylation or esterification of acids derived from animal fats, e.g., beef tallow or vegetable oils, such as soya, etc. Thus, the oleic acid precursor may be predominantly, e.g., from about 65-70% v/v, oleic acid, but may also contain linoleic acid, e.g., about 10-12% v/v, and may also include small amounts of stearic, palmitic and/or myristic acids.

The alkoxylate of the fuel additive may preferably be an ethoxylate, a propyloxylate, or a mixture thereof. The degree of ethoxylation is chosen to optimize performance in the blend with the oleic diethanolamide, and may be from about 0.5 to 20, more preferably from about 0.5 to about 10, and still more preferably from about 1 to about 3. A suitable product within this range would be, for example, that derived from the addition of 1 molecule of ethylene oxide to 1 mole of oleic acid.

In a particularly preferred embodiment, the fuel additive of the invention is characterized in that alcohols, and especially ethoxylated alcohols, are substantially absent from the fuel additive.

In another embodiment, the fuel additive of the invention may optionally comprise a nitrogen compound. The nitrogen compound preferably may be selected from the group consisting of ammonia, hydrazine, alkyl hydrazine, dialkyl hydrazine, urea, ethanolamine, monoalkyl ethanolamine, and dialkyl ethanolamine, wherein alkyl is independently selected from methyl, ethyl, n-propyl or isopropyl. Urea is particularly preferred. The nitrogen compound may be an anhydrous compound or a hydrous compound, e.g., an aqueous solution, and may be up to about 5% w/w aqueous solution.

4. Optional Fuel Blend Components

In one embodiment, the fuel blend may be prepared as a substantially anhydrous composition, save for trace water contamination. By the term trace water contamination we generally mean 0.1% w/w water or less. However, the fuel blends of the invention may optionally include up to about 5% v/v water, based on the total volume of the fuel blend.

The fuel blend of the invention may also optionally comprise a cetane booster in amount of from about 0.1% v/v to about 10% v/v. When a cetane booster is included in the fuel blend of the invention, it may be added as part of the fuel additive of the invention or it may be added separately.

A suitable cetane booster may be selected from: 2-ethylhexyl nitrate, tertiary butyl peroxide, diethylene glycol methyl ether, cyclohexanol, and mixtures thereof. The amount of cetane booster present in the mixture will generally be a function of the cetane value of the particular diesel fuel and the amount of ethanol present in the particular fuel blend. Generally, the lower the diesel fuel cetane value, the higher the amount of the cetane booster. Similarly, because ethanol typically acts as a cetane depressant, the higher the concentration of ethanol in the solution, the more cetane booster may be necessary in the blend.

Furthermore, the fuel additive or the fuel composition of the invention may also optionally include a demulsifier in an amount of less than about 5% v/v, and preferably less than about 1% v/v.

The Diesel Oxidation Catalyst

The diesel oxidation catalyst (DOC) useful in the methods of the present invention can be any DOC known in art. Generally, DOCs comprise a platinum group metal dispersed on a refractory metal oxide. By way of example, a DOC of the invention may comprise a monolithic catalyst element with through-flow passages of ceramic or metal, coated with an activity-promoting dispersion coating of a fine-particle metal oxide, such as aluminum oxide, titanium oxide, silicon oxide, zeolite or mixtures thereof as support for additional catalytically active components. The catalytically active components may be present in the form of platinum, palladium, rhodium and/or iridium doped with vanadium or in contact with an oxidic vanadium compound.

Alternatively, the DOC may comprise a catalytic material comprising a mixture of high surface area ceria, a zeolite and, optionally, a high surface area alumina. The catalytic material optionally may carry a low loading of platinum catalytic metal dispersed thereon, or palladium catalytic metal dispersed thereon. Alternatively, or in addition, the zeolite may be doped with a catalytic moiety, e.g., ion-exchanged or impregnated, with an ion or with a neutral metal-containing species selected from one or more of: hydrogen, platinum, rhodium, palladium, ruthenium, osmium, iridium, copper, iron, nickel, chromium and vanadium, preferably, one or both of platinum and iron.

Preferred zeolite materials for use in the DOCs of the invention include, for example, Beta zeolite or a zeolite selected from: Y-zeolite, pentasil (e.g., ZSM-5), Mordenite, and mixtures thereof.

Diesel Engine

The diesel engines that may be operated in accordance with the invention include all compression-ignition engines for both mobile (including marine) and stationary power plants. These include diesel engines of the two-stroke per cycle and four-stroke per cycle types. The diesel engines include heavy duty diesel engines. Included are on and off-highway engines, including new engines as well as in-use engines. The diesel engines that can be used include those used in automobiles, trucks, buses, locomotives, and the like. These include urban buses, as well as all classes of trucks.

### EXAMPLES

The invention will now be illustrated, but in no way limited, with reference to the accompanying examples.

### Example 1

### Preparation of Ethanol/Diesel Blends

Exemplary ethanol/diesel fuel blends of the invention are made by mixing a fuel additive with an ethanol/diesel mixture. More particularly, a fuel additive composition is made up by blending constituents, the diethanolamide of oleic acid and ethoxylated oleic acid in the ratio of: 1:1. One percent of this fuel additive composition is then added to 7.7% ethanol/92.3% diesel blends, including, e.g., certification diesel, US No. 1 diesel, 10% aromatic diesel containing 0.1% cetane improver resulting in stable, optically clear and stable micro-emulsion fuel blends.

### Example 2

### Combination of DOC and Ethanol/Diesel Fuel Blends

The unexpected improvement in the reduction of PM from diesel exhaust according to the method of the present invention may be demonstrated as follows. The US EPA Engine Dynamometer Schedule for Heavy-Duty Diesel Engines described in CFR Title 40 part 86, Appendix I may be used as the base testing sequence. The regulated emissions are determined over a cold cycle followed by four hot start transient test cycles, each cycle separated by the required 20 minute soak period. During the three hot start phases of the test, the emission characterization measurements from the 13 mode testing are obtained.

Exemplary ethanol/diesel fuel blends are comprised of Canadian No. 1 and No. 2 Diesels base fuels, and blends of each with 7.0% ethanol and 1% stabilizing additive. The diesel oxidation catalyst is comprised of a model AZ29 catalyst, and is verified under the US EPA Voluntary Diesel Retrofit program. The catalyst has a loading of Platinum on a molecular sieve containing washcoat.

The emission collection apparatus utilizes a constant volume sampling system which allows measurement of the true mass of the gaseous and particulate matter emissions from the engine during operation. The design of this sampling and analytical system follows the protocol of the CFR Title 40 Part 86.1310-90. The continuous sampling and analysis systems for CO, CO₂, NOₓ and THC conform to the specifications of CFR Title 40 Part 86.1310-90 and part 86.1339-90(3). Particulate matter emission rates are obtained using methods described in CFR Title 40 Part 86.1339-90.

The engine may be a 2000 model year Navistar DT466 S/N, details as follows:

| | |
|---|---|
| Bore (mm) | 116.5 |
| Stroke (mm) | 118.9 |
| Cycles | 4-stroke |
| Cylinders | In-line 6 |
| Displacement (litres) | 7.6 |
| Curb-Idle Speed (rpm) | 700 |
| Rated Test Speed (rpm) | 2200 |
| Maximum Torque (ft-lb) | 620 @ 1400 rpm |
| Maximum Power (hp) | 237 @ 2300 rpm |

As can be seen in the table below, when using base Diesels #1 and #2, the DOC reduces PM by 8.5% and 24.3% respectively. However, in the presence of 7% by volume ethanol in the two diesels, the DOC reduces PM by 39.4% and 46.0% respectively. In this regard, a synergy of action can be seen in the reduction of PM. For instance, the reduction in PM that results from use of a DOC with standard Diesel #1 is about 0.006 g/hp-hr, and the reduction in PM that results from use of the Ethanol/Diesel #1 without a DOC is about 0.002 g/hp-hr. Based on such results, and taken additively, an overall reduction in PM of approximately 0.008 g/hp-hr, or an 11.27% reduction in PM, would be expected. However, the combined use of a DOC with an Ethanol/Diesel #1 mixture is seen to synergistically reduce PM by about 0.028 g/hp-hr, or a 39.43% reduction in PM. Moreover, the overall content of NOₓ, as well of other pollutants, is still reduced.

Summary of average hot start emission rates for criteria pollutants and CO₂.

| | Emission | CO | CO₂ | NO | NOₓ | THC | PM | Change | % Change |
|---|---|---|---|---|---|---|---|---|---|
| Fuel Used | Control | [g/hp-hr] | [g/hp-hr] | [g/hp-hr] | [g/hp-hr] | [g/hp-hr] | [g/hp-hr] | in PM | in PM |
| Diesel #1 | Engine Out | 1.08 | 548 | 4.30 | 4.61 | 0.22 | 0.071 | Baseline | N/A |
| Diesel #1 | DOC | 0.20 | 550 | 4.37 | 4.59 | 0.05 | 0.065 | 0.006 | 8.45% |
| Ethanol- | Engine Out | 1.01 | 570 | 4.09 | 4.49 | 0.66 | 0.069 | 0.002 | 2.82% |
| Diesel #1 | | | | | | | | | |
| Ethanol- | DOC | 0.21 | 562 | 4.34 | 4.35 | 0.21 | 0.043 | 0.028 | 39.43% |
| Diesel #1 | | | | | | | | | |
| Diesel #2 | Engine Out | 1.17 | 558 | 4.26 | 4.60 | 0.21 | 0.074 | Baseline | N/A |
| Diesel #2 | DOC | 0.16 | 567 | 4.59 | 4.80 | 0.03 | 0.056 | 0.018 | 24.32% |
| Ethanol- | Engine Out | 1.23 | 560 | 4.12 | 4.55 | 0.56 | 0.075 | −0.001 | — |
| Diesel #2 | | | | | | | | | |
| Ethanol- | DOC | 0.25 | 573 | 4.46 | 4.58 | 0.16 | 0.040 | 0.034 | 45.95% |
| Diesel #2 | | | | | | | | | |

All standards, publications, and patent applications cited herein are incorporated by reference to the same extent as if each individual standard, publication, or patent application was specifically and individually indicated to be incorporated by reference.

Although certain embodiments have been described in detail above, those having ordinary skill in the art will clearly understand that many modifications are possible in the embodiments without departing from the teachings thereof. All such modifications are intended to be encompassed within the claims of the invention.

What is claimed:

1. A method of reducing particulate matter content of diesel engine exhaust, said method comprising:
operating a diesel engine utilizing as the fuel an ethanol/diesel fuel blend; and
contacting the exhaust resulting from the combustion of said ethanol/diesel fuel blend with a diesel oxidation catalyst (DOC) for an amount of time sufficient to reduce the particulate matter content by at least 25%, as compared to the particulate matter content of diesel engine exhaust resulting from the combustion of diesel fuel alone.

2. The method of claim 1, wherein the base diesel fuel of said ethanol/diesel fuel blend comprises a fuel additive, ethanol, and a diesel fuel.

3. The method of claim 1, wherein said fuel additive comprises an oleic alkanolamide and an alkoxylated oleic acid.

4. The method of claim 1, wherein the base diesel fuel of said ethanol/diesel fuel blend is present in a concentration of between about 80% and about 98% by volume.

5. The method of claim 1, wherein the ethanol of said ethanol/diesel fuel blend is present in a concentration of between about 2% and about 20% by volume.

6. The method of claim 1, wherein the ethanol of said ethanol/diesel fuel blend is fuel grade ethanol, optionally derived from petrochemical or agricultural sources.

7. The method of claim 1, wherein the ethanol/diesel fuel blend is a clear, homogeneous solution or microemulsion, stabilized by a blend of non-ionic surfactants.

8. The method of claim 7, wherein the surfactant stabilizer is present in the fuel blend at concentrations of from about 0.1% to 3% by volume of said fuel blend.

9. The method of claim 1, wherein said DOC comprises a loading of platinum metal on a molecular sieve.

10. The method of claim 1, wherein the exhaust is contacted with said diesel oxidation catalyst (DOC) for an amount of time sufficient to reduce the particulate matter content by at least 40%, as compared to the particulate matter content of diesel engine exhaust resulting from the combustion of diesel fuel alone.
